(19) United States
(12) Patent Application Publication
(10) Pub. No.: US 2022/0316188 A1
(43) Pub. Date: Oct. 6, 2022

(54) DISPLAY SYSTEM, REMOTE OPERATION SYSTEM, AND DISPLAY METHOD

(71) Applicant: Komatsu Ltd., Tokyo (JP)

(72) Inventor: Kazuhisa Takahama, Tokyo (JP)

(73) Assignee: Komatsu Ltd., Tokyo (JP)

(21) Appl. No.: 17/629,518

(22) PCT Filed: Jul. 31, 2020
(86) PCT No.: PCT/JP2020/029485

§ 371 Date: Jun. 22, 2022

(30) Foreign Application Priority Data
Jul. 31, 2019 (JP) 2019-141680

(51) Int. Cl. E02F 9/26; G06T 17/20; E02F 9/20

(52) U.S. Cl. CPC E02F 9/261; G06T 17/20; E02F 9/205; E02F 3/7609

(57) ABSTRACT

A display system includes a display device, an imaging device that is provided at a work machine, a three-dimensional measurement device that is provided at the work machine, and a display control device that, based on three-dimensional terrain data in a movement direction of the work machine measured by the three-dimensional measurement device, causes a symbol image indicating a terrain height in the movement direction to be superimposed on a terrain image in the movement direction captured by the imaging device, causing the display device to display the obtained image thereon.

### FIELD

The present disclosure relates to a display system, a remote operation system, and a display method.

### BACKGROUND

In a technical field related to work machines, a remote operation system as disclosed in Patent Literature 1 is known.

### CITATION LIST

### Patent Literature

Patent Literature 1: JP 2016-160741 A

### SUMMARY

### Technical Problem

When a two-dimensional image of a work site is displayed on a display device of the remote operation system, an operator may have difficulty in sufficiently recognizing a three-dimensional shape of the work site. For example, when a work machine is caused to travel by remote operation, there is a possibility that the work efficiency is lowered, if the operator cannot sufficiently recognize the terrain in a movement direction of the work machine.

An object of the present disclosure is to suppress a decrease in work efficiency of a work machine.

### Solution to Problem

According to an aspect of the present invention, a display system comprises: a display device; an imaging device that is provided at a work machine; a three-dimensional measurement device that is provided at the work machine; and a display control device that, based on three-dimensional terrain data in a movement direction of the work machine measured by the three-dimensional measurement device, causes a symbol image indicating a terrain height in the movement direction to be superimposed on a terrain image in the movement direction captured by the imaging device, causing the display device to display the obtained image thereon.

### Advantageous Effects of Invention

According to the present disclosure, it is possible to suppress a decrease in work efficiency of the work machine.

### BRIEF DESCRIPTION OF DRAWINGS

FIG. 1 is a diagram schematically illustrating a remote operation system according to the present embodiment.

FIG. 2 is a diagram of a work machine according to the present embodiment.

FIG. 3 is a functional block diagram illustrating a display control device according to the present embodiment.

FIG. 4 is a diagram illustrating a mesh image according to the present embodiment.

FIG. 5 is a diagram illustrating a symbol image according to the present embodiment.

FIG. 6 is a diagram illustrating a display device according to the present embodiment.

FIG. 7 is a flowchart illustrating a display method according to the present embodiment.

FIG. 8 is a block diagram illustrating a computer system according to the present embodiment.

### DESCRIPTION OF EMBODIMENTS

Embodiments according to the present disclosure will be described below with reference to the drawings, but the present disclosure is not limited to the description. Component elements according to the embodiments described below may be appropriately combined with each other. Furthermore, some of the component elements are not used in some cases.

[Overview of Remote Operation System]

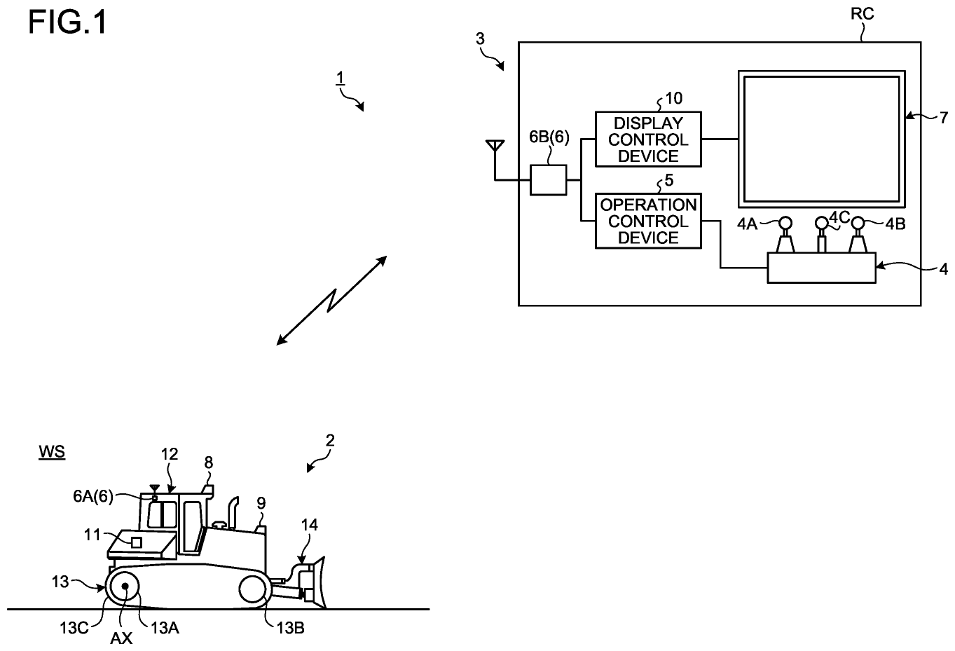

FIG. 1 is a diagram schematically illustrating a remote operation system 1 according to the present embodiment. The remote operation system 1 remotely operates a work machine 2. In the present embodiment, the work machine 2 is a bulldozer.

The remote operation system 1 includes a display system 3, an operation device 4, an operation control device 5, and a communication system 6. The display system 3 includes a display device 7, an imaging device 8, a three-dimensional measurement device 9, and a display control device 10.

The work machine 2 is operated on a work site WS. The operation device 4, the operation control device 5, the display device 7, and the display control device 10 are provided in a remote operation facility RC outside the work machine 2. The work machine 2 includes a vehicle control device 11. Each of the operation control device 5 and the display control device 10 wirelessly communicates with the vehicle control device 11 via the communication system 6. The communication system 6 includes a communication device 6A that is provided at the work machine 2 and a communication device 6B that is provided at the remote operation facility RC.

An operator remotely operates the work machine 2 by operating the operation device 4. The operation control device 5 generates an operation command on the basis of the operation of the operation device 4. The operation command generated by the operation control device 5 is transmitted to the vehicle control device 11 via the communication system 6. The vehicle control device 11 operates the work machine 2 on the basis of the operation command.

The imaging device 8 is provided at the work machine 2. The three-dimensional measurement device 9 is provided at the work machine 2. The imaging device 8 images the work site WS and acquires image data indicating an image of the work site WS. The image data acquired by the imaging device 8 is transmitted to the display control device 10 via the communication system 6. The three-dimensional measurement device 9 measures the work site WS and acquires three-dimensional data indicating a three-dimensional shape of the work site WS. The three-dimensional data acquired by the three-dimensional measurement device 9 is transmitted to the display control device 10 via the communication system 6. The display control device 10 causes the display device 7 to display an image related to the work site WS, on the basis of the image data and three-dimensional data of the work site WA. The operator operates the operation device 4 while referring to the image displayed on the display device 7.

The work machine 2 includes a vehicle body 12, a travel device 13 that supports the vehicle body 12, and working equipment 14 connected to the vehicle body 12. The travel device 13 includes drive wheels 13A each of which is a rotating body rotating about a rotation axis AX, idler wheels 13B, and crawler belts 13C each of which is supported by each drive wheel 13A and idler wheel 13B.

[Coordinate Systems]

In the present embodiment, a global coordinate system (Xg, Yg, Zg), a local coordinate system (X1, Y1, Z1), a camera coordinate system (Xc, Yc, Zc), and a measurement coordinate system (Xd, Yd, Zd) are defined to describe positional relationships between the respective units.

The global coordinate system (Xg, Yg, Zg) refers to a three-dimensional coordinate system based on the origin defined on the earth. The global coordinate system is defined by a global navigation satellite system (GNSS). The GNSS is a global navigation satellite system. An example of the global navigation satellite system includes a global positioning system (GPS). The GNSS detects the latitude indicating a position in an Xg-axis direction, the longitude indicating a position in a Yg-axis direction, and the altitude indicating a position in the Zg-axis direction.

The local coordinate system (X1, Y1, Z1) refers to a three-dimensional coordinate system based on the origin defined at the vehicle body 12 of the work machine 2. In the local coordinate system, a front-back direction, a left-right direction, and an up-down direction are defined. An X1 axis direction represents the front-back direction. A +X1 direction represents a forward direction, and a −X1 direction represents a backward direction. A Y1 axis direction represents the left-right direction. A +Y1 direction represents a rightward direction, and a −Y1 direction represents a leftward direction. The rotation axis AX of the drive wheel 13A extends in the Y1 axis direction. The Y1 axis direction is synonymous with a vehicle width direction of the work machine 2. A Z1 axis direction represents the up-down direction. A +Z1 direction represents an upward direction and a −Z1 direction represents a downward direction. A ground contact surface of each crawler belt 13C is orthogonal to the Z1 axis.

The camera coordinate system (Xc, Yc, Zc) refers to a three-dimensional coordinate system based on the origin defined at an imaging element of the imaging device 8.

The measurement coordinate system (Xd, Yd, Zd) refers to a three-dimensional coordinate system based on the origin defined at a detection element of the three-dimensional measurement device 9.

[Overview of Work Machine]

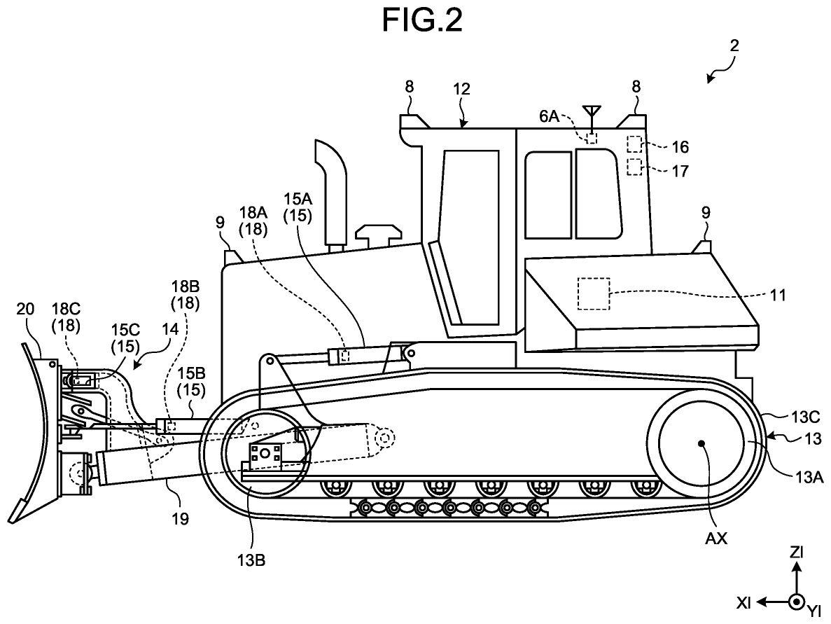

FIG. 2 is a diagram of the work machine 2 according to the present embodiment. The work machine 2 includes the vehicle body 12, the travel device 13, the working equipment 14, a hydraulic cylinder 15, the communication device 6A, the imaging device 8, the three-dimensional measurement device 9, a position sensor 16, a vehicle body attitude sensor 17, a working equipment attitude sensor 18, and the vehicle control device 11.

The travel device 13 supports the vehicle body 12. The idler wheel 13B is arranged in front of the drive wheel 13A. Each of the drive wheel 13A and the idler wheel 13B is a rotating body that rotates about the rotation axis AX. The rotation axis AX extends in the vehicle width direction of the work machine 2. The drive wheel 13A is driven by power generated by a drive source such as a hydraulic motor. The drive wheel 13A is rotated by operating the operation device 4. The crawler belt 13C is rotated by the rotation of the drive wheel 13A. The work machine 2 travels by the rotation of the crawler belt 13C.

The working equipment 14 is movably coupled to the vehicle body 12. The working equipment 14 includes a lift frame 19 and a blade 20.

The lift frame 19 is supported by the vehicle body 12 so as to be turnable in the up-down direction. The lift frame 19 supports the blade 20.

The blade 20 is arranged in front of the vehicle body 12. The blade 20 moves in the up-down direction in cooperation with the lift frame 19.

The hydraulic cylinder 15 generates power for moving the working equipment 14. The hydraulic cylinder 15 includes a lift cylinder 15A that moves the blade 20 in the up-down direction, an angle cylinder 15B that rotates the blade 20 in an angle direction, and a tilt cylinder 15C that turns the blade 20 in a tilt direction.

The imaging device 8 captures a terrain image TI that indicates an image of a terrain WA in the movement direction of the work machine 2. An example of the imaging device 8 includes a video camera that is capable of capturing a moving image. In a case where the work machine 2 moves forward, the imaging device 8 captures the terrain image TI in front of the work machine 2. In a case where the work machine 2 travels backward, the imaging device 8 captures the terrain image TI in back of the work machine 2. In the present embodiment, the imaging device 8 is provided at a roof portion of a cab of the vehicle body 12. The imaging device 8 is provided at each of the front portion and rear portion of the roof portion to capture each of the terrain image TI in front of the work machine 2 and the terrain image TI in back of the work machine 2. Note that the imaging device 8 is preferably arranged at a position where the terrain image TI in the movement direction of the work machine 2 can be captured. For example, the imaging device 8 may be arranged inside the cab.

The three-dimensional measurement device 9 measures three-dimensional terrain data TD indicating a three-dimensional shape of the terrain WA in the movement direction of the work machine 2. Examples of the three-dimensional measurement device 9 include a radar sensor, a laser sensor, and a stereo camera that are capable of measuring a three-dimensional shape of an object. In a case where the work machine 2 moves forward, the three-dimensional measurement device 9 measures the three-dimensional terrain data TD in front of the work machine 2. In a case where the work machine 2 travels backward, the three-dimensional measurement device 9 measures the three-dimensional terrain data TD in back of the work machine 2. In the present embodiment, the three-dimensional measurement device 9 is provided at a hood portion of the vehicle body 12 lower than the roof portion. The three-dimensional measurement device 9 is provided at each of the front portion and rear portion of the hood portion to measure each of the three-dimensional terrain data TD in front of the work machine 2 and the three-dimensional terrain data TD in back of the work machine 2. The three-dimensional measurement device 9 is preferably arranged at a position where the three-dimensional terrain data TD in the movement direction of the work machine 2 can be measured. For example, the three-dimensional measurement device 9 may be arranged at the roof portion of the cab or may be arranged inside the cab.

The position sensor 16 detects the position of the vehicle body 12 in the global coordinate system. The position sensor 16 is provided at the vehicle body 12. The position sensor 16 includes a global navigation satellite system (GNSS) sensor that detects the position of the vehicle body 12 by using GNSS. A plurality of position sensors 16 is provided at the vehicle body 12. The plurality of position sensors 16 is provided to calculate the orientation of the vehicle body 12 in the global coordinate system, on the basis of detection data of the plurality of position sensors 16.

The vehicle body attitude sensor 17 detects the attitude of the vehicle body 12 in the local coordinate system. The vehicle body attitude sensor 17 is provided at the vehicle body 12. The vehicle body attitude sensor 17 includes an inertial measurement unit (IMU). The attitude of the vehicle body 12 includes a roll angle indicating an inclination angle of the vehicle body 12 around the X1 axis, a pitch angle indicating an inclination angle of the vehicle body 12 around the Y1 axis, and a yaw angle indicating an inclination angle of the vehicle body 12 around the Z1 axis.

The working equipment attitude sensor 18 detects the attitude of the working equipment 14 in the local coordinate system. The working equipment attitude sensor 18 is provided in the hydraulic cylinder 15. The working equipment attitude sensor 18 detects an operation amount of the hydraulic cylinder 15. The working equipment attitude sensor 18 includes a rotation roller that detects the position of a rod of the hydraulic cylinder 15 and a magnetic force sensor that returns the position of the rod to the origin. Note that the working equipment attitude sensor 18 may be an angle sensor that detects an inclination angle of the working equipment 14.

The working equipment attitude sensor 18 includes a lift attitude sensor 18A that is provided in the lift cylinder 15A, an angle attitude sensor 18B that is provided in the angle cylinder 15B, and a tilt attitude sensor 18C that is provided in the tilt cylinder 15C. The lift attitude sensor 18A detects an operation amount of the lift cylinder 15A. The angle attitude sensor 18B detects an operation amount of the angle cylinder 15B. The tilt attitude sensor 18C detects an operation amount of the tilt cylinder 15C.

The vehicle control device 11 controls the work machine 2 on the basis of the operation command transmitted from the operation control device 5. As illustrated in FIG. 1, the operation device 4 includes a travel lever 4A that operates the travel device 13, an operation lever 4B that operates the hydraulic cylinder 15, and a forward/backward travel switching lever 4C that switches the movement direction of the work machine 2 between a forward direction and a backward direction. The vehicle control device 11 drives at least one of the travel device 13 and the working equipment 14 on the basis of the operation command generated on the basis of the operation of the operation device 4.

[Display Control Device]

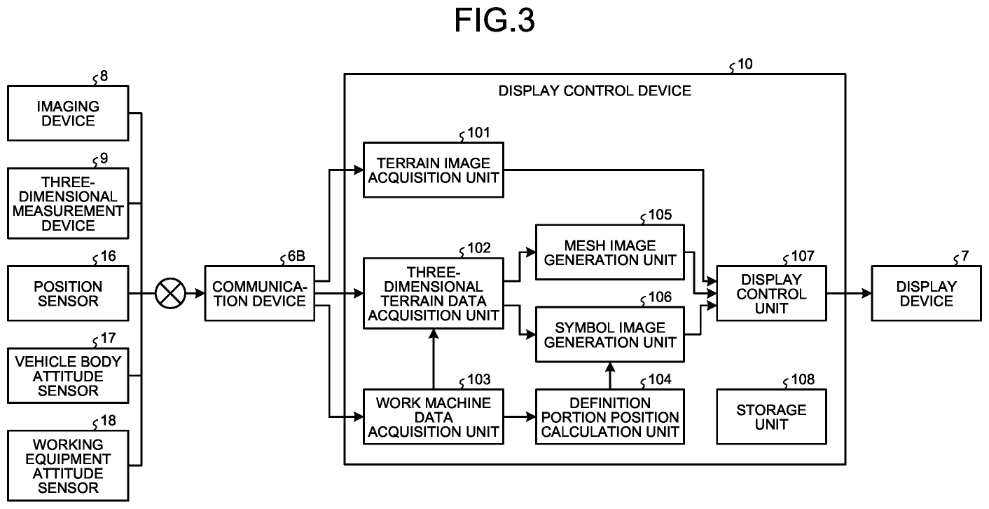

FIG. 3 is a functional block diagram illustrating the display control device 10 according to the present embodiment. In the present embodiment, on the basis of the three-dimensional terrain data TD in the movement direction of the work machine 2 measured by the three-dimensional measurement device 9, the display control device 10 causes a symbol image SI indicating a terrain height in the movement direction to be superimposed on the terrain image TI in the movement direction captured by the imaging device 8, causing the display device 7 to display the obtained image thereon.

As illustrated in FIG. 3, the display control device 10 is connected to each of the communication device 6B and the display device 7. The display control device 10 acquires, via the communication device 6B, the terrain image TI captured by the imaging device 8, the three-dimensional terrain data TD measured by the three-dimensional measurement device 9, vehicle body position data indicating the position of the vehicle body 12 detected by the position sensor 16, vehicle body attitude data indicating the attitude of the vehicle body 12 detected by the vehicle body attitude sensor 17, and working equipment attitude data indicating the attitude of the working equipment 14 detected by the working equipment attitude sensor 18. The display device 7 includes a flat panel display such as a liquid crystal display (LCD) or an organic electroluminescence display (OELD). Note that the display device 7 may include a projector device.

The display control device 10 includes a terrain image acquisition unit 101, a three-dimensional terrain data acquisition unit 102, a work machine data acquisition unit 103, a definition portion position calculation unit 104, a mesh image generation unit 105, a symbol image generation unit 106, a display control unit 107, and a storage unit 108.

The terrain image acquisition unit 101 acquires the terrain image TI in the movement direction of the work machine 2 captured by the imaging device 8.

The three-dimensional terrain data acquisition unit 102 acquires the three-dimensional terrain data TD in the movement direction of the work machine 2 measured by the three-dimensional measurement device 9.

The work machine data acquisition unit 103 acquires the vehicle body position data detected by the position sensor 16, the vehicle body attitude data detected by the vehicle body attitude sensor 17, and the working equipment attitude data detected by the working equipment attitude sensor 18.

The definition portion position calculation unit 104 calculates the position of a definition portion SP defined at least at a part of the work machine 2. For example, the definition portion SP may be defined at an outermost portion of the work machine 2 in the vehicle width direction, or may be defined at least at a part of the working equipment 14. In the present embodiment, the definition portion SP is defined at both ends of the blade 20 in a width direction. In the bulldozer, both ends of the blade 20 in the width direction are outermost portions of the work machine 2 in the vehicle width direction.

The definition portion position calculation unit 104 calculates the position of the definition portion SP in the global coordinate system, on the basis of the vehicle body position data, the vehicle body attitude data, and the working equipment attitude data.

The definition portion position calculation unit 104 calculates the position of the definition portion SP in the local coordinate system, on the basis of working equipment data indicating the dimensions and outer shape of the working equipment 14, and the working equipment attitude data acquired by the work machine data acquisition unit 103. The dimensions of the working equipment 14 include the length of the lift frame 19 and the length of the blade 20. The outer shape of the working equipment 14 includes the outer shape of the blade 20. The working equipment data is known data that can be derived from design data or specification data of the work machine 2, and is stored in advance in the storage unit 108. The definition portion position calculation unit 104 calculates an inclination angle θ1 of the lift frame 19 relative to the vehicle body 12 on the basis of detection data of the lift attitude sensor 18A. The definition portion position calculation unit 104 calculates an inclination angle θ2 of the blade 20 relative to the lift frame 19 in the angle direction, on the basis of detection data of the angle attitude sensor 18B. The definition portion position calculation unit 104 calculates an inclination angle θ3 of the blade 20 relative to the lift frame 19 in the tilt direction, on the basis of detection data of the tilt attitude sensor 18C. The definition portion position calculation unit 104 can calculate the position of the definition portion SP in the local coordinate system, on the basis of the working equipment data stored in the storage unit 108, and the working equipment attitude data including the inclination angle θ1, the inclination angle θ2, and the inclination angle θ3.

By converting the position of the definition portion SP in the local coordinate system to the position of the definition portion SP in the global coordinate system on the basis of the vehicle body position data and vehicle body attitude data acquired by the work machine data acquisition unit 103, the definition portion position calculation unit 104 calculates the position of the definition portion SP in the global coordinate system.

The mesh image generation unit 105 generates a mesh image MI indicating the three-dimensional shape of the surface of the terrain WA around the work machine 2, on the basis of the three-dimensional terrain data TD acquired by the three-dimensional terrain data acquisition unit 102.

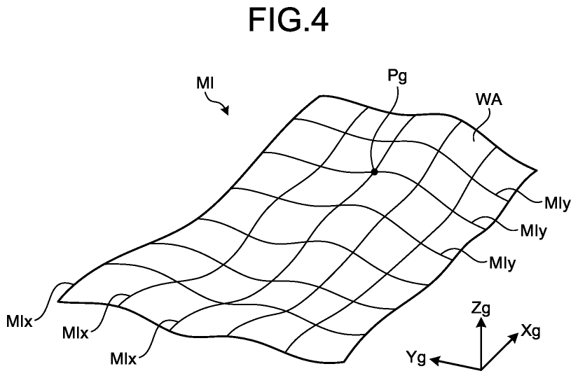

FIG. 4 is a diagram illustrating the mesh image MI according to the present embodiment. The mesh image MI is generated along the surface of the terrain WA. The mesh image MI includes a plurality of points Pg indicating the position of the surface of the terrain WA in the global coordinate system, a first line MIx extending in the Xg-axis direction and connecting the plurality of points Pg, and a second line MIy extending in the Yg-axis direction and connecting the plurality of points Pg. The plurality of points Pg is provided in a matrix on the surface of the terrain WA. A plurality of points Pg is provided in the Xg-axis direction and a plurality of points Pg is provided in the Yg-axis direction. Each of the plurality of points Pg indicates a position in the Xg-axis direction, a position in the Yg-axis direction, and a position in the Zg-axis direction, on the surface of the terrain WA.

The first line MIx extends in the Xg-axis direction so as to connect a plurality of points Pg provided in the Xg-axis direction. A plurality of the first lines MIx is provided at intervals in the Yg-axis direction. The second line MIy extends in the Yg-axis direction so as to connect a plurality of points Pg provided in the Yg-axis direction. A plurality of second lines MIy is provided at intervals in the Xg-axis direction. In the present embodiment, the plurality of first lines MIx is provided at equal intervals in the Yg-axis direction. The plurality of second lines MIy are provided at equal intervals in the Xg-axis direction. Each point Pg is defined at an intersection point of the first line MIx and the second line MIy.

The symbol image generation unit 106 generates the symbol image SI indicating the terrain height in the movement direction of the work machine 2. The symbol image SI indicates an intersection portion CL where a definition plane VP passing through the definition portion SP of the blade 20 intersects at least part of the surface of the terrain WA in the movement direction of the work machine 2.

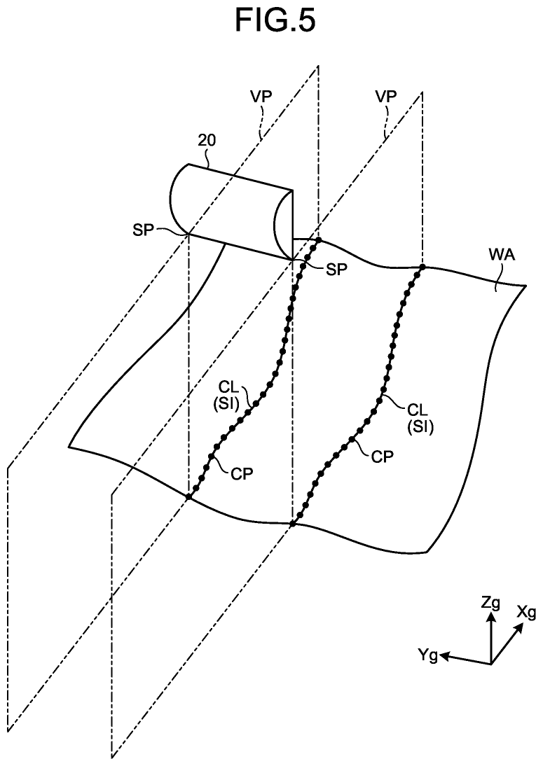

FIG. 5 is a diagram illustrating the symbol image SI according to the present embodiment. The symbol image generation unit 106 sets the definition plane VP passing through the definition portion SP of the blade 20. The definition plane VP is a virtual plane intersecting the definition portion SP and crossing the surface of the terrain WA. The definition plane VP is parallel to an X1-Z1 plane including the X1 axis and the Z1 axis of the local coordinate system. The symbol image SI indicates the intersection portion CL where the definition plane VP passing through the definition portion SP intersects at least part of the surface of the terrain WA in the movement direction of the work machine 2. The definition plane VP is substantially orthogonal to the surface of the terrain WA. In the present embodiment, the definition plane VP is set to be orthogonal to the rotation axis AX of the drive wheel 13A. The intersection portion CL includes an intersection line extending in the movement direction along the surface of the terrain WA.

The intersection portion CL is an aggregate of a plurality of intersection points CP each indicating a position in the Xg-axis direction, a position in the Yg-axis direction, and a position in the Zg-axis direction on the surface of the terrain WA. The plurality of intersection points CP is arranged in the movement direction of the work machine 2 along the surface of the terrain WA. The terrain height indicated by the symbol image SI represents a position of the intersection point CP in the Zg-axis direction. The intersection portion CL indicates a three-dimensional shape of the terrain WA which the work machine 2 traveling forward passes through.

The display control unit 107 causes the symbol image SI indicating the terrain height in the movement direction of the work machine 2 generated by the symbol image generation unit 106 to be superimposed on the terrain image TI in the movement direction of the work machine 2 acquired by the terrain image acquisition unit 101, causing the display device 7 to display the obtained image thereon.

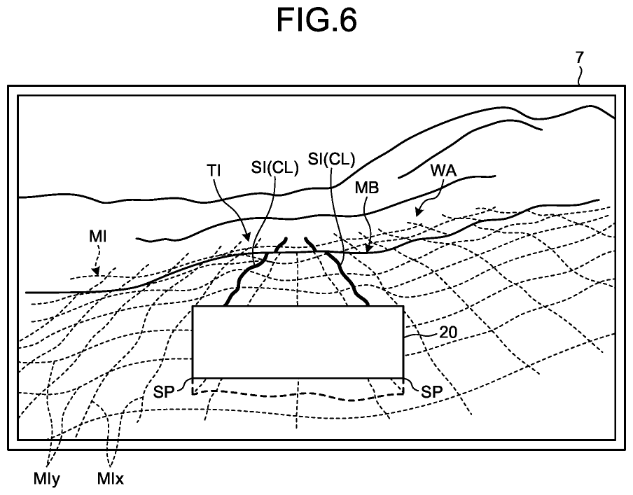

FIG. 6 is a diagram illustrating the display device 7 according to the present embodiment. As illustrated in FIG. 6, the display control unit 107 causes the symbol image SI indicating the terrain height in the movement direction of the work machine 2 to be superimposed on the terrain image TI in the movement direction of the work machine 2 captured by the imaging device 8, causing the display device 7 to display the obtained image thereon. In the present embodiment, the display control unit 107 causes both of the symbol image SI indicating the terrain height in the movement direction of the work machine 2 and the mesh image MI indicating the three-dimensional shape of the surface of the terrain WA around the work machine 2 to be superimposed on the terrain image TI, causing the display device 7 to display the obtained image thereon.

The display control unit 107 causes the display device 7 to display the symbol image SI and the mesh image MI in different display forms. The display control unit 107 causes the display device 7 to display the symbol image SI and the mesh image MI so that the symbol image SI is intensified relative to the mesh image MI. In the present embodiment, the mesh image MI is represented by a dotted line having a first thickness, and the symbol image SI is represented by a solid line having a second thickness larger than the first thickness.

The symbol image SI is generated separately from the mesh image MI. The symbol image SI and the mesh image MI may be displayed so as to be superimposed on each other on a display screen of the display device 7, or may be displayed so as not to be superimposed on each other. As illustrated in FIG. 6, in the present embodiment, the display control unit 107 causes the display device 7 to display the symbol image SI and the mesh image MI so that the symbol image SI is not superimposed on the first line MIx of the mesh image MI.

The symbol image SI is generated on the basis of the intersection portion CL (intersection line) where the definition plane VP passing through the definition portion SP defined on the blade 20 intersects the surface of the terrain WA in the movement direction of the work machine 2. In the present embodiment, the definition portion SP is defined at both ends of the blade 20 in the width direction. Therefore, two symbol images SI are displayed on the display device 7 so as to correspond to both ends of the blade 20 in the width direction.

Each of the symbol images SI indicates the terrain height in the movement direction of the work machine 2. Therefore, the operator can intuitively recognize the terrain WA in the movement direction of the work machine 2 by checking the symbol images SI displayed on the display device 7. Furthermore, when there is a step MB in the movement direction of the work machine 2, the display control unit 107 does not display the symbol image SI at the step MB. The step MB is a step where the terrain WA ahead is lower than the terrain WA closer to the work machine 2 in the movement direction. The step MB has a portion on the surface of the terrain WA that cannot be measured by the three-dimensional measurement device 9. For example, in a case where the three-dimensional measurement device 9 includes a laser radar (laser imaging detection and ranging: LIDAR), a portion that is not irradiated with a detection wave emitted from the laser radar is generated on the surface of the terrain WA due to the step MB. Therefore, the display control unit 107 does not display the symbol image SI at the step MB. As illustrated in FIG. 6, the intersection portion CL is discontinuous at the step MB. Similarly, the display control unit 107 does not display the mesh image MI at the step MB. Therefore, the operator can recognize that the step MB is located in the movement direction of the work machine 2.

[Display Method]

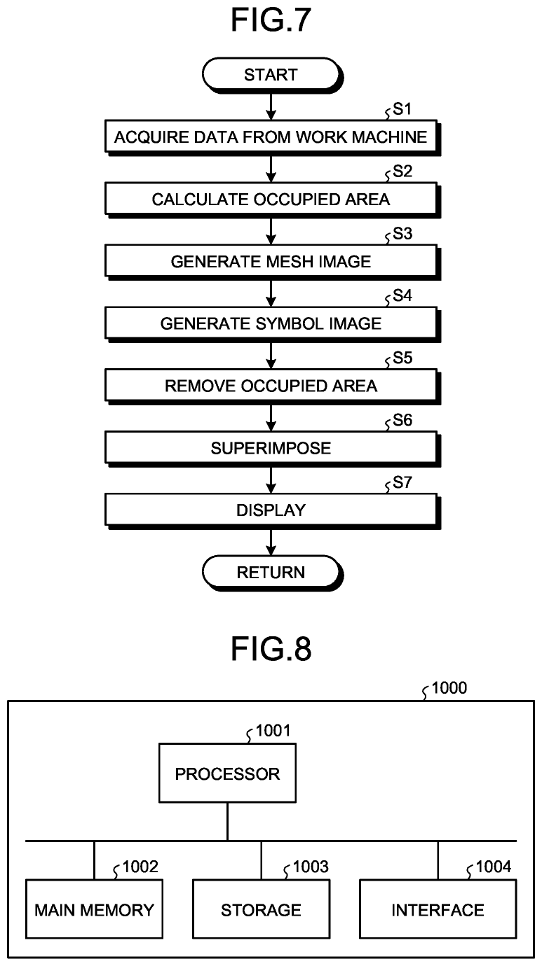

FIG. 7 is a flowchart illustrating a display method according to the present embodiment. The terrain image acquisition unit 101 acquires the terrain image TI from the imaging device 8. The three-dimensional terrain data acquisition unit 102 acquires the three-dimensional terrain data TD from the three-dimensional measurement device 9. The work machine data acquisition unit 103 acquires the vehicle body position data from the position sensor 16, acquires the vehicle body attitude data from the vehicle body attitude sensor 17, and acquires the working equipment attitude data from the working equipment attitude sensor 18 (Step S1).

The terrain image TI acquired in Step S1 is defined in the camera coordinate system. The three-dimensional terrain data TD is defined in the measurement coordinate system. The vehicle body position data is defined in the global coordinate system. The vehicle body attitude data and the working equipment attitude data are defined in the local coordinate system.

Next, the three-dimensional terrain data acquisition unit 102 calculates an occupied area indicating an area occupied by the vehicle body 12 and the working equipment 14, on the basis of the three-dimensional terrain data TD (Step S2).

The vehicle body 12 or the working equipment 14 may at least partially enter a measurement area of the three-dimensional measurement device 9. Therefore, the three-dimensional terrain data acquisition unit 102 removes the occupied area of the vehicle body 12 and the working equipment 14 from the three-dimensional terrain data TD. The area occupied by the vehicle body 12 in the measurement area of the three-dimensional measurement device 9 is known data and is stored in the storage unit 108. In addition, the three-dimensional terrain data acquisition unit 102 can calculate the area occupied by the working equipment 14 in the measurement area of the three-dimensional measurement device 9, on the basis of the working equipment data stored in the storage unit 108 and the working equipment attitude data. The occupied area is defined in the local coordinate system. The three-dimensional terrain data acquisition unit 102 converts the occupied area in the local coordinate system to the occupied area in the global coordinate system.

The mesh image generation unit 105 generates the mesh image MI on the basis of the three-dimensional terrain data TD (Step S3).

The three-dimensional terrain data TD is defined in the measurement coordinate system. The mesh image generation unit 105 converts the three-dimensional terrain data TD in the measurement coordinate system to three-dimensional terrain data TD in the global coordinate system. The mesh image generation unit 105 generates the mesh image MI described with reference to FIG. 4, on the basis of the three-dimensional terrain data TD defined in the global coordinate system. The mesh image MI generated by the mesh image generation unit 105 is output to the display control unit 107.

The definition portion position calculation unit 104 calculates the position of the definition portion SP of the work machine 2. The symbol image generation unit 106 generates the symbol image SI on the basis of the position of the definition portion SP and the three-dimensional terrain data TD (Step S4).

As described above, in the present embodiment, the definition portion SP is defined at both ends of the blade 20 in the width direction. The definition portion position calculation unit 104 calculates the position of the definition portion SP in the local coordinate system, on the basis of the working equipment data stored in the storage unit 108 and the working equipment attitude data acquired by the work machine data acquisition unit 103. In addition, the definition portion position calculation unit 104 converts the position of the definition portion SP in the local coordinate system to the position of the definition portion SP in the global coordinate system, by using the vehicle body position data and the vehicle body attitude data acquired by the work machine data acquisition unit 103. The symbol image generation unit 106 converts the three-dimensional terrain data TD in the measurement coordinate system to the three-dimensional terrain data TD in the global coordinate system. As described with reference to FIG. 5, the symbol image generation unit 106 calculates the intersection portion CL where the definition plane VP passing through the definition portion SP intersects the surface of the terrain WA in the movement direction of the work machine 2, in the global coordinate system. The symbol image generation unit 106 generates the symbol image SI on the basis of the intersection portion CL. The symbol image SI generated by the symbol image generation unit 106 is output to the display control unit 107.

The display control unit 107 removes the occupied area calculated in Step S2 from the mesh image MI and the symbol image SI (Step S5).

The display control unit 107 causes the mesh image MI and the symbol image SI from which the occupied area has been removed in Step S5 to be superimposed on the terrain image TI acquired in Step S1 (Step S6).

After converting the mesh image MI and the symbol image SI of the global coordinate system to the mesh image MI and the symbol image SI of the camera coordinate system, the display control unit 107 causes the mesh image MI and the symbol image SI to be superimposed on the terrain image TI.

As illustrated in FIG. 6, the display control unit 107 causes the display device 7 to display the superimposed terrain image TI, mesh image MI, and symbol image SI (Step S7).

In FIG. 6, for ease of viewing, the vehicle body 12 that is part of the occupied area is not illustrated, and only the blade 20 is illustrated.

[Computer System]

FIG. 8 is a block diagram illustrating a computer system 1000 according to the present embodiment. The display control device 10 described above includes the computer system 1000. The computer system 1000 includes a processor 1001 such as a central processing unit (CPU), a main memory 1002 which includes a nonvolatile memory such as a read only memory (ROM) and a volatile memory such as a random access memory (RAM), a storage 1003, and an interface 1004 which includes an input/output circuit. The function of the display control device 10 described above is stored, as a computer program, in the storage 1003. The processor 1001 reads the computer program from the storage 1003, loads the program in the main memory 1002, and executes the processing described above according to the computer program. Note that the computer programs may be distributed to the computer system 1000 via a network.

According to the embodiment described above, the computer program can execute, on the basis of the three-dimensional terrain data TD in the movement direction of the work machine 2, generating the symbol image SI indicating the terrain height in the movement direction, and causing the symbol image SI to be superimposed on the terrain image TI in the movement direction, causing the display device 7 to display the obtained image thereon.

[Effects]

As described above, according to the present embodiment, the terrain image TI in the movement direction of the work machine 2 captured by the imaging device 8 and the symbol image SI indicating the terrain height in the movement direction of the work machine 2 are displayed on the display device 7 in a superimposed manner. Therefore, when the work machine 2 is caused to travel by remote control, the operator can fully recognize the terrain WA in the movement direction of the work machine 2 by referring to the symbol image SI. The reference to the symbol image SI makes it possible for the operator to recognize unevenness of the terrain WA in the movement direction of the work machine 2, an obstacle in the movement direction of the work machine 2, or a recess MB in the movement direction of the work machine 2. Therefore, the operator can cause the work machine 2 to travel while recognizing the situation in the movement direction of the work machine 2. For example, the operator can operate the operation device 4 so that the work machine 2 may not make contact with the obstacle, or operate the operation device 4 so that the work machine 2 may not fall into the recess MB. Therefore, a decrease in work efficiency of the work machine 2 is suppressed.

The mesh image MI is displayed on the display device 7 together with the terrain image TI and the symbol image SI. Therefore, the operator can recognize the three-dimensional shape of the terrain WA around the work machine 2 by referring to the mesh image MI. In addition, displaying the symbol image SI and the mesh image MI in the different display forms makes it possible for the operator to recognize the terrain WA in the movement direction of the work machine 2, referring to the symbol image SI, and to recognize the terrain WA around the work machine 2, referring to the mesh image MI.

The symbol image SI indicates the intersection portion CL where the definition plane VP passing through the definition portion SP of the work machine 2 intersects at least part of the surface of the terrain WA in the movement direction of the work machine 2. Therefore, the symbol image SI can appropriately represent the terrain WA through which the work machine 2 travels in the movement direction.

The intersection portion CL is the intersection line extending in the movement direction of the work machine 2 along the surface of the terrain WA. Displaying, as the symbol image SI, the intersection line extending in the movement direction on the display device 7 allows the operator to refer to the symbol image SI to fully recognize the terrain WA in the movement direction of the work machine 2.

The definition portion SP is the outermost portion in the vehicle width direction of the work machine 2. The symbol image SI can appropriately show the terrain WA through which the outermost portion of the work machine 2 in the vehicle width direction passes.

[Other Embodiments]

In the embodiment described above, the definition portion SP has been defined at both ends of the blade 20 in the width direction. The definition portion SP may be defined, for example, at the center of the blade 20 in the width direction. Furthermore, the definition portion SP may not be defined at the working equipment 14, and may be defined, for example, at the crawler belt 13C. For example, the definition portions SP may be defined at both ends in the vehicle width direction of the crawler belts 13C. The definition portions SP defined at both ends in the vehicle width direction of the crawler belts 13C make it possible for the symbol images SI to indicate a traveling width indicating an area through which the travel device 13 of the work machine 2 passes.

In the embodiment described above, the symbol image SI (intersection portion CL) has been the intersection line extending in the movement direction of the work machine 2 along the surface of the terrain WA. The symbol image SI may be the intersection points CP or marks that are displayed in the movement direction of the work machine 2.

In the embodiment described above, the definition plane VP passing through the definition portion SP has been orthogonal to the rotation axis AX and parallel to the X1-Z1 plane of the local coordinate system. The definition plane VP may not be orthogonal to the rotation axis AX. Furthermore, the definition plane VP may be defined on the basis of the global coordinate system. For example, the definition plane VP may be parallel to a plane including an axis parallel to the movement direction of the work machine 2 and an axis parallel to the vertical direction. In a case where the movement direction of the work machine 2 is parallel to the Xg axis of the global coordinate system, the definition plane VP may be parallel to an Xg-Zg plane including the Xg axis and the Zg axis of the global coordinate system. The symbol image SI may indicate the intersection portion CL where the definition plane VP defined in the global coordinate system intersects at least part of the surface of the terrain WA in the movement direction of the work machine 2.

In the embodiment described above, the symbol image SI indicating the terrain height in the movement direction of the work machine 2 traveling forward has been displayed on the display device 7. The symbol image SI indicating the terrain height in the movement direction of the work machine 2 traveling backward may be displayed on the display device 7. In addition, in a case where an excavation member called a ripper that is capable of excavating an excavation target is provided at a rear portion of the work machine 2, the definition portion SP may be defined at the excavation member. In addition, the display of the symbol image SI indicating the terrain height in front of the work machine 2 and the display of the symbol image SI indicating the terrain height in back of the work machine 2 may be switched by operating the forward/backward travel switching lever 4C.

In the embodiment described above, the mesh image MI and the symbol image SI have been generated on the basis of the three-dimensional terrain data TD acquired by the three-dimensional measurement device 9 during the travel of the work machine 2. In other words, the mesh image MI and the symbol image SI have been generated on the basis of the three-dimensional terrain data TD acquired in real time. The three-dimensional terrain data TD acquired in the past may be stored in the storage unit 108 to generate the mesh image MI and the symbol image SI on the basis of the three-dimensional terrain data TD stored in the storage unit 108. For example, since the three-dimensional terrain data TD defined in the global coordinate system is stored in the storage unit 108, the mesh image generation unit 105 can smoothly generate the mesh image MI around the work machine 2, on the basis of the three-dimensional terrain data TD stored in the storage unit 108. The symbol image generation unit 106 can smoothly generate the symbol image SI in the movement direction of the work machine 2, on the basis of the three-dimensional terrain data TD stored in the storage unit 108.

In the embodiment described above, the mesh image MI may not be displayed on the display device 7.

In the embodiment described above, the work machine 2 has been the bulldozer. The work machine 2 may be an excavator or a wheel loader. In a case where the work machine 2 is the excavator, the outermost portion of the work machine 2 in the vehicle width direction is often the crawler belt. In a case where the work machine 2 is the excavator, the definition portion SP may be defined at the crawler belt. Note that even in a case where the work machine 2 is the excavator, the definition portion SP may be defined at least at a part of the working equipment including a bucket.

### REFERENCE SIGNS LIST

1 REMOTE OPERATION SYSTEM

2 WORK MACHINE

3 DISPLAY SYSTEM

4 OPERATION DEVICE

4A TRAVEL LEVER

4B OPERATION LEVER

4C FORWARD/BACKWARD TRAVEL SWITCHING LEVER

5 OPERATION CONTROL SYSTEM

6 COMMUNICATION SYSTEM

6A COMMUNICATION DEVICE

6B COMMUNICATION DEVICE

7 DISPLAY SYSTEM

8 IMAGING DEVICE

9 THREE—DIMENSIONAL MEASUREMENT DEVICE

10 DISPLAY CONTROL DEVICE

11 VEHICLE CONTROL DEVICE

12 VEHICLE BODY

13 TRAVEL DEVICE

13A DRIVE WHEEL

13B IDLER WHEEL

13C CRAWLER BELT

14 WORKING EQUIPMENT

15 CYLINDER

15A LIFT CYLINDER

15B ANGLE CYLINDER

15C TILT CYLINDER

16 POSITION SENSOR

17 VEHICLE BODY ATTITUDE SENSOR

18 WORKING EQUIPMENT ATTITUDE SENSOR

18A LIFT ATTITUDE SENSOR

18B ANGLE ATTITUDE SENSOR

18C TILT ATTITUDE SENSOR

19 LIFT FRAME

20 BLADE

101 TERRAIN IMAGE ACQUISITION UNIT

102 THREE—DIMENSIONAL TERRAIN DATA ACQUISITION UNIT

103 WORK MACHINE DATA ACQUISITION UNIT

104 DEFINITION PORTION POSITION CALCULATION UNIT

105 MESH IMAGE GENERATION UNIT

106 SYMBOL IMAGE GENERATION UNIT

107 DISPLAY CONTROL UNIT

108 STORAGE UNIT

AX ROTATION AXIS

CL INTERSECTION PORTION

CP INTERSECTION POINT

MB STEP

MI MESH IMAGE

MIx FIRST LINE

MIy SECOND LINE

RC REMOTE OPERATION FACILITY

SI SYMBOL IMAGE

SP DEFINITION PORTION

TD THREE—DIMENTIONAL TERRAIN DATA

TI TERRAIN IMAGE

VP DEFINITION PLANE

WA TERRAIN

WS WORK SITE

1. A display system comprising:
a display device;
an imaging device that is provided at a work machine;
a three-dimensional measurement device that is provided at the work machine; and
a display control device that, based on three-dimensional terrain data in a movement direction of the work machine measured by the three-dimensional measurement device, causes a symbol image indicating a terrain height in the movement direction to be superimposed on a terrain image in the movement direction captured by the imaging device, causing the display device to display the obtained image thereon.

2. The display system according to claim 1, wherein
the display control device causes the display device to display a mesh image indicating a three-dimensional shape of terrain around the work machine, in a display form different from that of the symbol image.

3. The display system according to claim 1 or 2, wherein
the symbol image indicates an intersection portion where a definition plane passing through a definition portion of the work machine intersects at least part of a surface of the terrain in the movement direction.

4. The display system according to claim 3, wherein
the intersection portion includes an intersection line extending in the movement direction along a surface of the terrain.

5. The display system according to claim 3 or 4, wherein
the definition portion includes an outermost portion of the work machine in a vehicle width direction.

6. The display system according to any of claims 3 to 5, wherein
the work machine includes a vehicle body and a travel device that includes a rotating body rotating about a rotation axis, and
the definition plane is orthogonal to the rotation axis.

7. The display system according to claim 6, wherein
the work machine includes working equipment connected to the vehicle body, and
the definition portion is defined at least at a part of the working equipment.

8. The display system according to claim 7, wherein
the working equipment includes a blade, and
the definition portion is defined at both ends of the blade in a width direction.

9. The display system according to claim 7 or 8, further comprising:
a position sensor that detects a position of the vehicle body;
a vehicle body attitude sensor that detects an attitude of the vehicle body; and
a working equipment attitude sensor that detects an attitude of the working equipment, wherein
the display control device calculates a position of the definition portion based on the position of the vehicle body, the attitude of the vehicle body, and the attitude of the working equipment.

10. The display system according to any of claims 1 to 9, wherein
the display device is provided outside the work machine.

11. A remote operation system comprising:
a display device that is provided outside a work machine;
an operation device that remotely operates the work machine; and
a display control device that, based on three- dimensional terrain data in a movement direction of the work machine measured by a three-dimensional measurement device provided at the work machine, causes a symbol image indicating a terrain height in the movement direction to be superimposed on a terrain image in the movement direction captured by an imaging device provided at the work machine, causing the display device to display the obtained image thereon.

12. A display method comprising:
generating, based on three-dimensional terrain data in a movement direction of a work machine, a symbol image indicating a terrain height in the movement direction; and
causing the symbol image to be superimposed on a terrain image in the movement direction, causing a display device to display the obtained image thereon.
